(19) United States
(12) Patent Application Publication
(10) Pub. No.: US 2014/0111978 A1
(43) Pub. Date: Apr. 24, 2014

(54) PADDLE

(71) Applicant: Peter David Laurence, Belmont (AU)

(72) Inventor: Peter David Laurence, Belmont (AU)

(21) Appl. No.: 14/047,082

(22) Filed: Oct. 7, 2013

(30) Foreign Application Priority Data
Oct. 18, 2012 (AU) 2012904582

(51) Int. Cl. F21V 33/00; F21V 31/00; B63H 16/04

(52) U.S. Cl. CPC F21V 33/008; B63H 16/04; F21V 31/005
USPC 362/109

(57) ABSTRACT

A paddle (10) comprising an elongate handle (12), a paddle blade (14) fixed to the elongate handle (12) and an illumination source, wherein the illumination source illuminates at least part of the paddle blade (12).

### CROSS-REFERENCE TO RELATED APPLICATION(S)

This application claims priority to Australian Provisional Patent Application No. 2012904582 filed on Oct. 18, 2012 (which is hereby incorporated by reference herein), and benefit of the filing date of the foregoing application is hereby claimed under the provisions of 35 U.S.C. §119.

### FIELD OF THE INVENTION

The present invention relates to a paddle. More particularly, the paddle of the present invention is intended for use in increasing the visibility of the paddle, and consequently, of anyone using such a paddle, in low light situations.

### BACKGROUND ART

Typically, paddles for use with watercraft comprise at least one paddle blade fixed to an end of an elongated cylindrical shaft or handle. In use, a user will hold onto the handle using both hands and dip the blade into water whilst simultaneously drawing it through the water from bow to stern in order to propel the craft they are riding forward. Where the paddle has two blades fixed to opposing ends of the handle, a user will alternatively dip each blade into the water, whilst again simultaneously drawing it through the water from bow to stern in order to propel the craft forward.

There are many safety concerns with respect to the visibility of such craft to powerboat operators, mainly due to the low profile of many such craft in the water. This concern is increased when the craft is used at twilight or in darkness. Further, such craft, for example kayaks, skis and canoes, and paddle blades, are often constructed of a dark coloured plastic. This further contributes to the poor visibility of the paddler to powerboats operators under limited visibility conditions.

The general use of marine safety lighting is known in the prior art. Previous attempts to incorporate conventional marine lighting into kayaks and the like have included small lights mounted on the outer hull of the kayak or lights attached to the paddler.

Deck mounted lights typically comprise incandescent lamps or light emitting diodes (LEDs) which are attached to the upper deck of the kayak either by conventional adhesives or a removable suction cup. Such lights provide insufficient visibility as the lights are often small and set to a low output level to conserve battery life. Further, the path of the light may be blocked by the kayak operator, thus effectively presenting a large “blind spot” to approaching vessels.

Lights attached to the kayak operator themselves have included lamps suspended around the operator's neck or attached to the head of the operator. These light again are typically small and are completely obscured by the operator when a powerboat approaches the kayak from a rear direction.

Additionally, both of the abovementioned lighting methods are inefficient at attracting attention because the kayak is moving slowly and the light source is close to the waterline, making it difficult to see, particularly in rough waters where the light may be obscured by waves or mistaken as simply a reflection off the water.

Reflective water resistant tape may be affixed to the paddle blades and kayaks to enhance visibility. The US Coast Guard approves Safety of Life At Sea (SOLAS) tape for such use. However, in darkness such tape has little to no effect.

The paddle of the present invention has as one object thereof to overcome substantially the abovementioned problems associated with the prior art, or to at least provide a useful alternative thereto.

The preceding discussion of the background art is intended to facilitate an understanding of the present invention only. It should be appreciated that the discussion is not an acknowledgement or admission that any of the material referred to was part of the common general knowledge in Australia as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

The term “kayak” or “kayaks” used throughout the specification and claims is to be understood, unless the context requires otherwise, to include canoes, surf skis, wave skis, paddle boards, rafts, dinghies and other water borne craft which may be propelled by one or more paddles or oars.

The term “paddle” or “paddles” used throughout the specification and claims is to be understood, unless the context requires otherwise, to include oars or other arrangements adapted to be held by a user and to displace water under the power of that user.

### SUMMARY

In accordance with the present invention there is provided a paddle comprising an elongate handle, a paddle blade fixed to the elongate handle and an illumination source, wherein the illumination source illuminates at least part of the paddle blade.

Preferably, the elongate handle is substantially hollow.

Preferably, the illumination source is in the form of a light emitting diode (LED). More preferably, the LED is positioned within the elongate handle, in a manner so as to illuminate at least a portion of the paddle blade.

Preferably, the paddle blade is substantially transparent to aid its illumination by the illumination source.

Still preferably, the LED is housed in a plastic end cap which in turn is recessed into the end of the elongate handle.

In a preferred embodiment of the present invention, the paddle further comprises an electrics housing in which is provided a power source and switch incorporated therein.

Preferably, the power source and switch are electrically coupled to the illumination source.

Preferably, the electrics housing is recessed into the elongate handle. Still preferably, the electrics housing has a waterproof seal provided between it and the elongate handle.

The power source is preferably provided in the form of a battery. Preferably, the battery can be disconnected and replaced.

The power source and switch are electronically coupled to the LED by way of electronic wiring in such a way so as the actuation of the switch will turn the LED on and off. More preferably, the electrical housing further comprises a micro-controller configured to allow for varying operational modes of the LED. Preferably, the operational modes include continuous and flashing/blinking light patterns.

In one form of the present invention there is provided a second paddle blade fixed to the elongate handle.

Preferably, each paddle blade is affixed to an end (e.g. a different end) of the elongate handle.

Still preferably, the paddle further comprises a second illumination source electronically coupled to the electrics housing substantially as described hereinabove.

### BRIEF DESCRIPTION OF THE DRAWINGS

The present invention will now be described, by way of example only, with reference to one embodiment thereof and the accompanying drawings, in which:

FIG. 1 is a perspective view of a paddle in accordance with the present invention;

FIG. 2 is an exploded perspective view of the paddle of FIG. 1;

FIG. 3 is a perspective view of one end of the paddle of FIG. 1;

FIG. 4 is an exploded perspective view of one end of the paddle of FIG. 1;

FIG. 5 is an exploded perspective view of the electrics housing of the paddle of FIG. 1; and

FIG. 6 is a detailed perspective view of the electrics housing of the paddle of FIG. 1.

### DETAILED DESCRIPTION

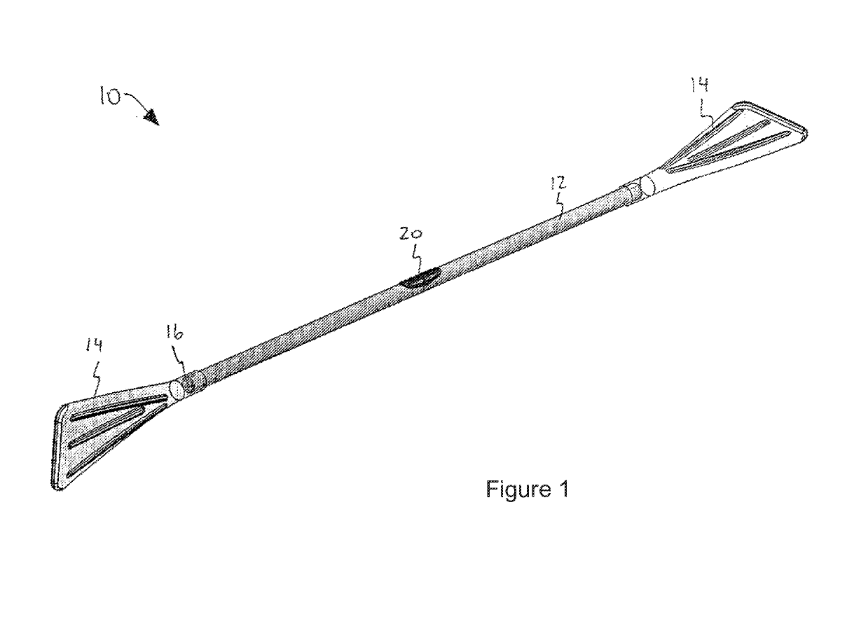

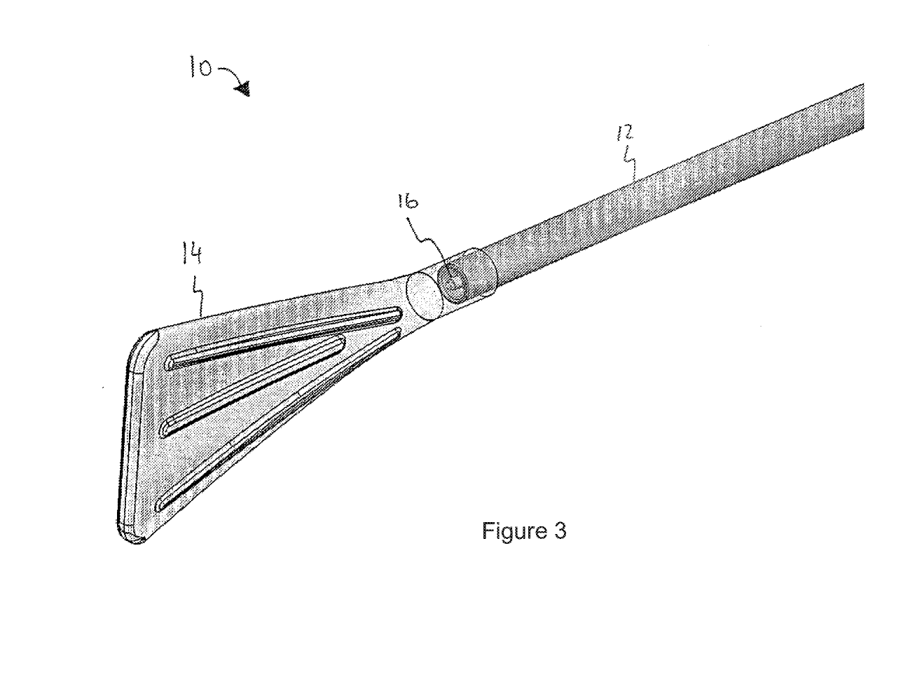

In FIGS. 1 to 6 there is shown a paddle 10 in accordance with the present invention. The paddle 10 comprises an elongate handle 12, a pair of paddle blades 14 each attached on opposing ends of the elongate handle 12 and a pair of illumination sources.

The elongate handle 12 is hollow and constructed from a strong, yet lightweight material, such as plastic, aluminium or carbon fibre. It is of a diameter such that it may be gripped by a user's hand (not shown).

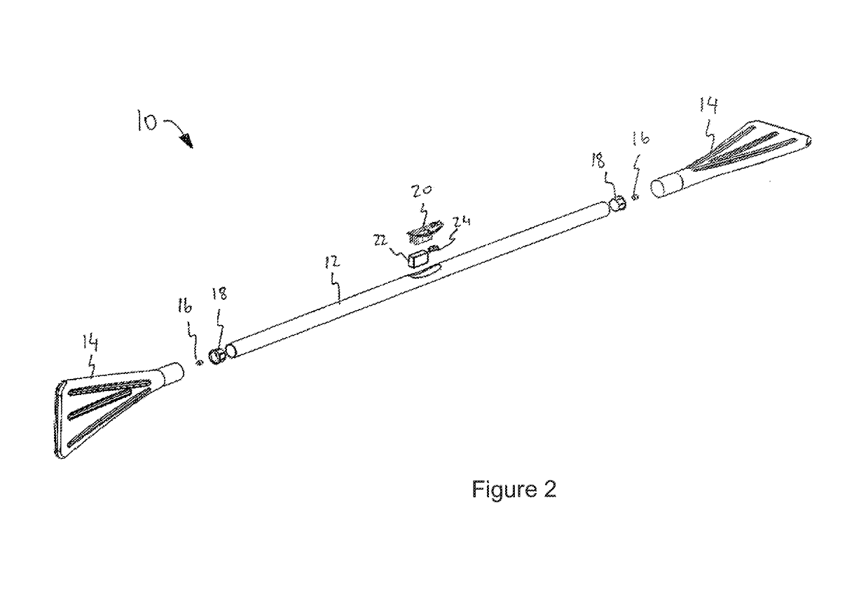

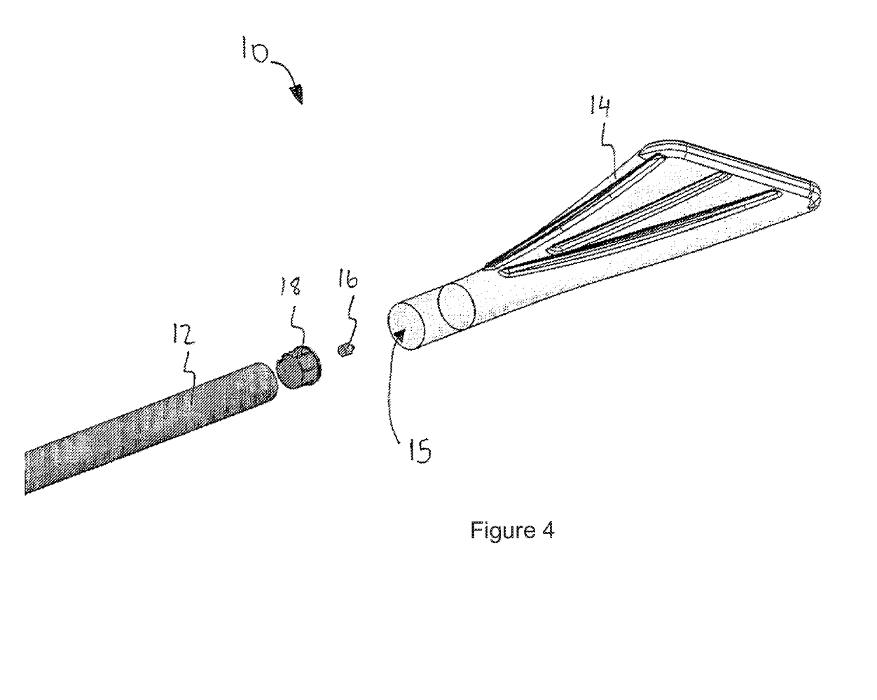

The paddle blades 14 are positioned on opposing ends of the elongate handle 12 in the manner of a conventional kayak paddle and the planes may be offset in a known manner. The paddle blades 14 are constructed from a clear plastic material and are moulded into the shape of a conventional kayak paddle blade. The blades 14 have a cavity 15 provided to receive the elongate handle 12 therein, best seen in FIGS. 2 and 4. The paddle blades 14 are secured onto the elongate handle 12 through adhesives in a manner to create a watertight seal. However, it is envisaged that the paddle blades 14 may be secured onto the elongate handle 12 by other means, such as a screw thread, in order to allow the blades 14 to be removed for replacement, transport or service.

Each illumination source is provided in the form of a light emitting diode (LED), for example a white single chip LED 16. High-brightness LEDs can also be utilised for scenarios where long distance vision is required. Further, the use of red-green-blue (RGB) LEDs can be utilised to differentiate between port and starboard sides if required.

The LEDs 16 are housed in end caps 18 which are recessed into the ends of elongate handle 12 and are configured for easy installation and removal. When positioned in this manner the LED 16 projects light into the paddle blade 14 from the inside, allowing the clear paddle blade 14 to be at least partially illuminated. The plastic end caps 18 further provide protection of the LEDs 16 from the shocks associated with paddling which may act to dislodge the LEDs 16 from their position. The configuration of the LEDs 16 within the paddle blades serves to provide a waterproof environment to protect them from water and mechanical damage.

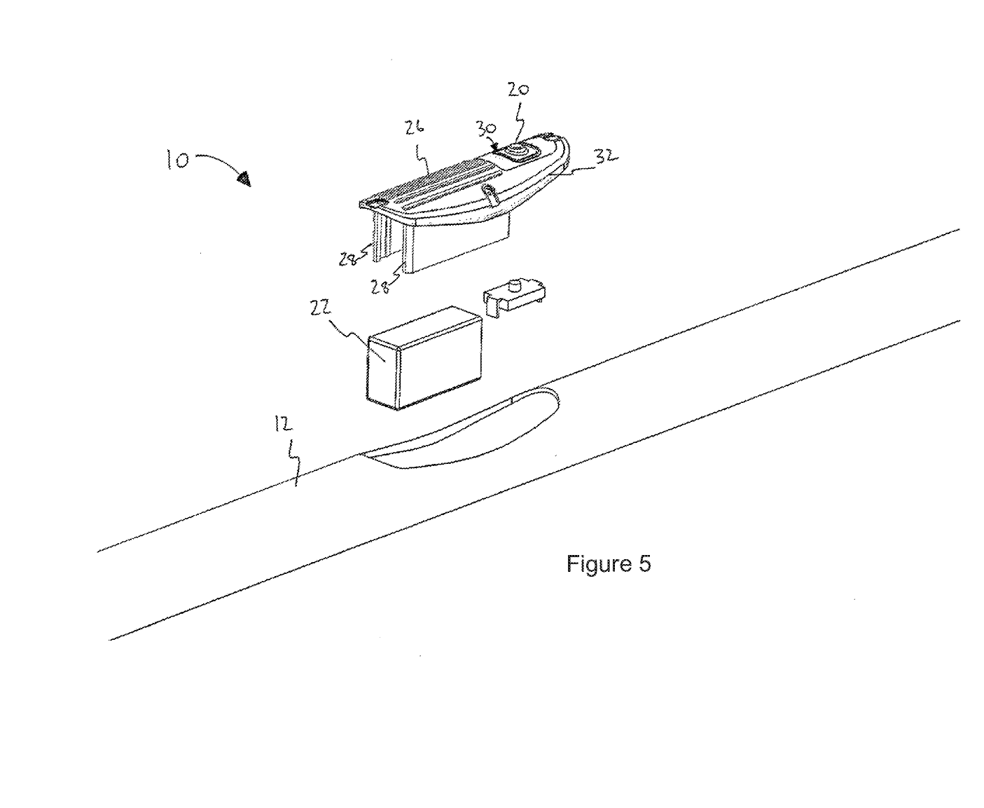

As shown in FIG. 5, there is provided in the elongate handle 12 an electrics housing 20, which in turn is provided with has a power source, such as a battery 22, and a switch 24 incorporated therein. The electrics housing 20 is provided at about the mid-point of the elongate handle 12, conveniently apart from where the elongate handle 12 will be gripped in use. The electrics housing 20 is constructed of a thick plastic top shell 26, with two parallel walls 28 extending downward from thereon to secure the battery 22. The electric housing 20 further comprises a substantially depressible area 30 beneath which the switch 24 can be secured in such a manner so as to be operable from the top side of the electrics housing 20.

The battery 22 may be any conventional battery technology, such as lithium ion, nickel-metal-hydrate, nickel-cadmium of alkaline and can either be disposable or rechargeable. The power source may also comprise multiple batteries, depending on the voltage requirements.

The switch 24 may be provided as a push button or rocker switch so as to increase ease of use during paddling. The depressible area 30 of the top shell 26 is constructed of a soft rubber or plastic in order provide waterproofing.

The power source 22 and switch 24 are electronically coupled to the LEDs 16 by means of standard insulated electronic wiring (not shown) and are connected by standard means. The electronic wiring is run through the interior of the elongate handle 12 to the LEDs 16.

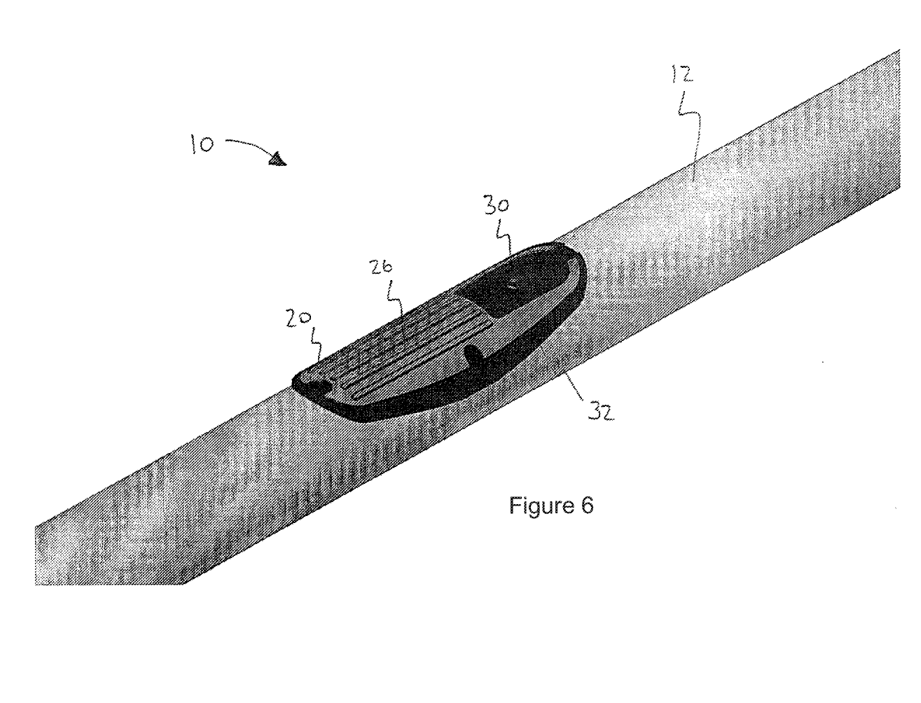

As shown in FIG. 6, the electrics housing 20 is recessed into the elongate handle 12 in such a way so that the top shell 26 is substantially flush with the elongate handle 12 and secured by way of screws (not shown). The electrics housing 20 is surrounded by a rubber seal 32 to ensure the electrics housing 20 and the interior of the elongate handle 12 are water tight.

The electrics housing 12 can further incorporate a micro-controller (not shown) which allows for varying modes of operation of the LEDs 16, where for example the LEDs 16 blink or the brightness can be altered. The operation of the switch 24 would trigger an interrupt in the micro-controller, wherein the interrupt advances the micro-controller into the next mode of LED operation.

In use, a user (not shown) can operate the kayak paddle 10 by actuating the switch 24 which will facilitate the electronic connection between the battery 22 and the LEDs 14, resulting in the operations of the LEDs 16 simultaneously to illuminate the paddle blades 14.

It is envisaged that the paddle 10 of the present invention may overcome the limitations of prior kayak light systems in many ways. As each paddle blade 14 is alternatively dipped into the water to propel the kayak, the opposing paddle blade 14 is swung upwards, well above the deck of the kayak and the head of the kayak operator. This position is therefore substantially higher than the mounting positions of previous kayak safety lights, allowing for increased visibility and conspicuity, whilst avoiding blind spot causing blockages. The motion of the blades 14 through use also draws the attention of a viewer. The alternation of dipping the paddle blades 14 into the water further leads to increased visibility through the creation of a blinking effect. Additionally, due to the position of the electrics housing 20 on the elongate handle 12 the user can easily and quickly illuminate the paddle blades 14 without the need to stop.

Modifications and variations such as would be apparent to the skilled addressee are considered to fall within the scope of the present invention. For example, whilst a double bladed paddle 10 is described above, it is envisaged that a single bladed paddle may be provided in accordance with the present invention.

1. A paddle comprising an elongate handle, a paddle blade fixed to the elongate handle and an illumination source, wherein the illumination source illuminates at least part of the paddle blade.

2. A paddle according to claim 1, wherein the elongate handle is substantially hollow.

3. A paddle according to claim 1, wherein the illumination source is in the form of a light emitting diode (LED).

4. A paddle according to claim 3, wherein the LED is positioned within the elongate handle, in a manner so as to illuminate at least a portion of the paddle blade.

5. A paddle according to claim 3, wherein the LED is housed in a plastic end cap which in turn is recessed into an end of the elongate handle.

6. A paddle, according to claim 1, wherein the paddle blade is substantially transparent to aid its illumination by the illumination source.

7. A paddle according to claim 1, wherein the paddle further comprises an electrics housing in which is provided a power source and switch incorporated therein.

8. A paddle according to claim 7, wherein the power source and switch are electrically coupled to the illumination source.

9. A paddle according to claims 7, wherein the electrics housing is recessed into the elongate handle.

10. A paddle according to claim 7, wherein the electrics housing has a waterproof seal provided between it and the elongate handle.

11. A paddle according to claim 7, wherein the power source is provided in the form of a battery.

12. A paddle according to claim 7, wherein the power source is provided in the form of a battery that can be disconnected and replaced.

13. A paddle according to claim 7, wherein the power source and switch are electronically coupled to the LED by way of electronic wiring in such a way so as the actuation of the switch will turn the LED on and off.

14. A paddle according to claim 7, wherein, the electrics housing further comprises a micro-controller configured to allow for varying operational modes of the illumination source, including continuous and flashing/blinking light patterns.

15. A paddle according to claim 1, wherein there is provided a second paddle blade fixed to the elongate handle.

16. A paddle according to claim 16, wherein each paddle blade is affixed to a different end of the elongate handle.

17. A paddle according to claim 16, wherein the paddle further comprises a second illumination source electronically coupled to the electrics housing.
